(19) United States
(12) Patent Application Publication
(10) Pub. No.: US 2004/0231649 A1
(43) Pub. Date: Nov. 25, 2004

(54) Mechanical supercharger

(76) Inventor: Erich Mueller, Oehringen (DE)

Correspondence Address: JORDAN AND HAMBURG LLP, 122 EAST 42ND STREET, SUITE 4000, NEW YORK, NY, 10168, US

(21) Appl. No.: 10/432,750

(22) PCT Filed: Nov. 27, 2001
(86) PCT No.: PCT/EP01/13843

(30) Foreign Application Priority Data
Nov. 28, 2000 (DE) 100 59 0691

(51) Int. Cl. F02B 33/00

(52) U.S. Cl. 123/559.1

(57) ABSTRACT

The invention relates to a mechanical superharger (1) for internal combustion engines for delivaing induction air under an increased pressure and with an increased density in a combustion chamber of the internal combustion engine. The inventive mechanical superchager is comprised of a compressor unit (3) having a compressor impeller for compressing the induction air, of a clutch (2) for connecting the engine crankshaft drive, and of a high ratio gearing (4) for transferring the rotary motion of the engine crankshaft drive to the compressor impeller, whereby the gearing is provided in the form of a circuar sliding gear drive (4).

The invention relates to a mechanical supercharger for internal combustion engines for delivering intake air of the introductory portion of claim 1.

In principle, superchargers can be compared to air pumps, which deliver intake air at an elevated pressure and a higher density to the combustion space of an internal combustion engine and, by these means, improve the filling of the latter. A differentiation is made here between so-called exhaust gas turbochargers, which utilize the flow energy of the exhaust gases, which otherwise would be lost, and so-called mechanical superchargers, which are driven by the crankshaft of the engine.

In the case of a supercharger with a mechanical drive, the engine crankshaft operation is transferred directly to the supercharger over an appropriate coupling, so that, depending on the design, a compressor wheel compresses a large amount of fresh gas during the intake cycle and supplies it to the cylinders. Such a supercharger is distinguished by a rapid build-up of the supercharging pressure and by a high torque even at the lower end of the rpm range.

Moreover, mechanical superchargers avoid the disadvantage of exhaust gas turbochargers, especially in the case of diesel engines. This disadvantage consists in that, at the lower end of the rpm range, because of the inertia of the exhaust gases, the exhaust gas turbocharger can react only with a slight delay to rapid changes in the position of the accelerator pedal (turbo hole), as a result of which the power is decreased briefly and the emission of soot is increased by a less than optimum combustion.

Since a mechanical supercharger does not intervene in the exhaust gas system of the engine, the moments of inertia of the exhaust gases, which always occur when there is a change in load, are without effect.

In order to ensure an appropriate transmission ratio of the engine-coupled drive over the coupling to the compressor wheel, preferably one-speed spur gears preferably are used in the art.

It is, however, a disadvantage of such one-speed spur gear transmission that, because of the high rpm and the long service life required, the transmission must be manufactured extremely precisely. This is necessarily associated with increased design and manufacturing expenditures and therefore with increased costs. Due to the high transmission ratio, which is furthermore required, such a transmission is subject to a high failure rate because of the breakdown susceptibility of the bearing elements resulting from corresponding engine vibrations.

A further disadvantage of such a transmission is the relatively large space required, which, on the one hand, limits the use in vehicles appreciably, depending on the space requirements present, and, on the other, makes retrofitting in already exiting constructions impossible. Moreover, the construction of such a supercharger is unwieldy and more difficult than necessary.

Starting out from the disadvantages, known from the state of the art, it is an object of the invention to create a supercharger, which while retaining a high efficiency and high torque, occupies a small space, can be produced actively inexpensively and is distinguished by a long service life.

For accomplishing this objective, the present invention proposes a mechanical supercharger with the distinguishing features of claim 1.

Further developments of the invention arise out of the dependent claims.

The invention is based on the principle that a so-called circular-thrust transmission, as known, for example, from DE 19515 146 C2, is used as a high gear ratio transmission.

The principle of a circular-thrust transmission is based on the fact that, by means of at least two so-called dummy crankshafts as well as one driving crankshaft with, in each case, identical radii, a plane is transposed into a circular-thrusting motion, that is, that each point of this plane carries out a circular motion without rotating about an axis, disposed non-rotationally through this plane, so that a circular thrust is carried out. Preferably, the two dummy crankshafts and the driving crankshaft are at the corner points of an acute angled, optionally equilateral triangle. In the case of a circular thrust transmission, this plane, so shaped, is formed by a toothed wheel, which meshes with another toothed wheel. It may be a question here, for example, of an internally toothed ring with an internal denticulation, in which a spur gear takes its course and which is transposed into a circular thrust, or of the spur gear itself.

Accordingly, such a circular thrust transmission function is based on the principle of the almost contactless immersion of the denticulation of the tooth pairings into one another and of the lateral, continuous displacement of the denticulation with the purpose of transferring torque. This takes place without tooth flanks rolling against one another. Engagement pulses do not occur since, during the transfer of the peripheral force, the teeth of the driving wheel and of the driven wheel lie flat on one another. Due to the circular thrust, a very slight, specific surface pressure on the teeth is achieved in the case of the toothed wheels.

Each point of the circularly thrusting part, whether it may be an internally toothed ring or a spur gear, has a peripheral velocity, which depends on the selected eccentricity of the driving crankshaft and the two dummy crankshafts as well as on the driving rpm. Accordingly, this velocity is also the velocity of the respective toothed area of the driving internally toothed ring or spur gear as it strikes the surface of the driven spur gear or internally toothed ring.

The surface velocity of the tooth flank of the output gear, whether spur gear or internally toothed ring, in uniform rotation depends on the output rpm, present as a result of the transmission ratio selected, and on the diameter selected for the output spur gear or the internally toothed ring.

Since the contact of the tooth flanks is over the full surface during the lateral thrust and not linear, as it is, for example, in the case of an elvolvent denticulation relatively large torques can be transferred accordingly with relatively small denticulations.

Since only relatively small denticulations are sufficient, the diameters of the toothed wheels used are also relatively small, so that a relatively small overall structural size can be brought about, while a large torque is retained. Moreover, since the forces transferred between the individual toothed flanks are smaller, inferior materials and, with that, cheaper materials can also be used.

Moreover, the full-surface contact between the teeth does not require the use of a lubricant for decreasing friction, wear and noise or for dissipating heat.

This is associated with the advantage that the transmission system, as such, is open, that is, does not have to be sealed to prevent the escape of lubricant, so that the flexibility of installing such a transmission is increased further.

In a preferred embodiment of the invention, the circular thrust transmission of the mechanical supercharger has an internally toothed ring with an inner denticulation, a spur gear with an outer denticulation, which is in engagement with the internally toothed ring and at least two dummy crankshafts, as well as a driving crankshaft, one of the toothed wheels undergoing a non-rotationally, circular, translational motion and the other toothed wheel being mounted so that it can rotate about a stationary axle.

The rotatably mounted axle can be a connecting shaft at the output or input side in the supercharger.

According to an advantageous development of the inventive mechanical supercharger, the internally toothed ring can be connected at the output side with the compressor wheel and the spur gear can be connected at the input side with the coupling, the spur gear being transposed into a rotation-free translational motion by the driving crankshaft.

Since such a circular thrust transmission, because of its design as a circular thrust transmission, does not have to be lubricated, the bearings, used in the transmission, can be constructed as ceramic bearings. Moreover, the teeth of the individual toothed wheels of the transmission can be formed from a material, which does not require lubrication, such as a plastic or a sintered metal.

In a further, preferred embodiment of the invention, the transmission and the compressor unit and optionally also the coupling are disposed in a single integral housing, the integral housing possibly containing integrated functional elements, such as bearing bushings, back-up washers, sealing elements and the like, depending on the design configuration.

In a further embodiment of the inventive supercharger, a planetary transmission is disposed as transmission between the coupling and the compressor unit and is constructed so concentrically, that it occupies a significantly more compact space.

According to a further advantageous development of the invention, the coupling is constructed as a magnetic coupling, which can be actuated electrically and switches the supercharger off, for example, while idling and switches the supercharger on while accelerating or under full load.

According to a yet further advantageous development of the invention, the transmission, disposed between the compressor unit and the coupling, additionally has a coupling device with a free-wheeling device, which replaces the magnetic coupling and is open when the engine is stopped and as required, and depending on the on the load condition, can be opened and closed using the gas pedal position and an appropriate electronic control program for the vehicle transmission.

Due to the use of a circular thrust transmission, the mechanical supercharger is distinguished by the advantages that it can be produced relatively inexpensively, that the denticulation does not have to be cooled or lubricated with oil, that the transmission itself occupies a smaller space and, as a result, the space for disposing the supercharger as a whole is reduced, and that the supercharger functions with less noise than do conventional superchargers, the necessary prerequisites of a high efficiency and a high torque, as well of a long service life and little maintenance work being retained.

Further advantages and development of the present invention arise out of the example, which does not in any way limit the invention and described in conjunction with the drawings, in which

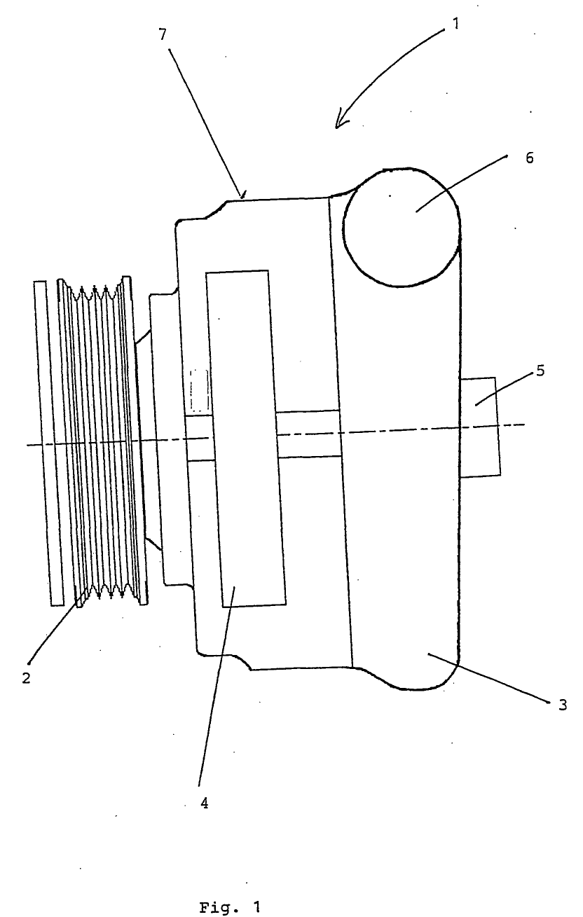

FIG. 1 shows a diagrammatic representation of the inventive mechanical supercharger and

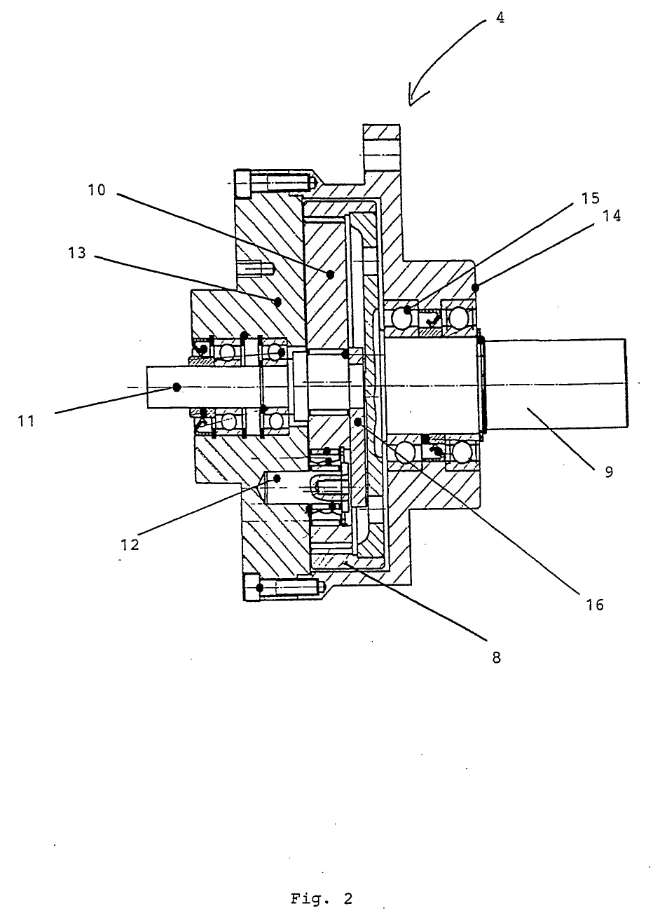

FIG. 2 shows a diagrammatic sectional representation of the circular thrust transmission of the mechanical supercharger of FIG. 1

In FIG. 1, a diagrammatic representation of an inventive mechanical supercharger is reproduced. A circular thrust transmission 4, which is shown diagrammatically here as a “black box”, is disposed between a magnetic coupling 2 and a compressor unit 3 with a compressor wheel, the details of which are not shown.

The compressor unit 3 has a suction side 5 and pressure side 6 for the intake air.

As can be seen, the circular thrust transmission 4 and the compressor unit 3 are integrated in a single, integral housing 7.

FIG. 2 diagrammatically shows the construction of the circular thrust transmission 4. The circular trust transmission 4 has an internally toothed ring 8, which has an internal denticulation and is connected on the output side with a connecting shaft 9 to the compressor wheel.

A spur gear 10 runs in the internally toothed ring 8 and is connected on the input side with a connecting shaft 11 to the magnetic coupling 2.

The spur gear is connected over at least two dummy crankshafts 12 with a flange 13, which is on the input side and in turn, is connected permanently with a flange 14, in which the connecting shaft 9 is mounted on the output side. The dummy crankshafts 12 are constructed as extenders, which are supported by ball bearings, as is a driving crankshaft, which is not shown and which transposes the spur gear 10 into a circular thrust.

All the ball bearings 15 in the circular thrust transmission 4 are constructed as ceramic bearings.

A counter weight 16 is disposed as centrifugal equalization mass at the spur gear 10.

1. A mechanical supercharger for an internal combustion engine for delivering intake air at an elevated pressure and with an increased density to a combustion site of the internal combustion engine, the internal combustion engine having a crankshaft, comprising a compressor having a compressor wheel for compressing the intake air, a coupling for switching on drive of the engine crankshaft and a high gear ratio circular thrust transmission for transferring the engine crankshaft drive to the compressor wheel.

2. The supercharger of claim 1, wherein the circular thrust transmission comprises an internally toothed ring, an externally toothed spur gear in engagement with the internally toothed ring, and at least two dummy crankshafts and a driving crankshaft, one of the internally toothed ring and spur gear undergoing a non-rotational, circular, translational motion and the other of the internally toothed ring and the spur gear being mounted for rotation about a stationary axle.

3. The supercharger of claim 2, wherein the internally toothed ring is connected on an output side of the compressor with the compressor wheel and the spur gear is connected on an input side of the compressor with a coupling.

4. The supercharger of claim 3, wherein the spur gear is connected with the dummy crankshafts and the driving crankshaft.

5. The supercharger of any one of claims 1 to 4, wherein the toothed wheel and the spur gear are straight toothed or helically toothed.

6. The supercharger of claims 1 to 4, wherein the circular thrust transmission is lubricant-free.

7. The supercharger of claim 6, wherein the teeth of the toothed wheel and the spur gear are formed from a material which does not require any lubrication.

8. The supercharger of claim 6 or 7, wherein the circular thrust transmission further comprises ceramic bearings.

9. The supercharger of one of claims 1 to 4, wherein the transmission further comprises a coupling device with a free-wheeling device.

10. The supercharger of claim 9, further comprising means for controlling the coupling device in response to position of an accelerator pedal.

11. The supercharger of claim 1, wherein the transmission is a concentrically constructed planetary transmission.

12. The supercharger of claim 11, further comprising an oil-tight partition between the transmission and the compressor unit.

13. The supercharger of any one of claims 1 to 4, further comprising a single integral housing in which the transmission and the compressor are disposed.

14. The supercharger of claim 13, wherein the coupling is disposed in the integral housing.

15. The supercharger of claim 14, wherein the integral housing (7) is comprised of an aluminum die-casting or a plastic.

16. The supercharger of claim 15, wherein the compressor and the transmission are integrated in the integral housing.

17. The supercharger of any one of claims 1 to 4, wherein the coupling comprises an electrically actuatable magnetic coupling.
